(19) United States
(12) Patent Application Publication
(10) Pub. No.: US 2015/0110153 A1
(43) Pub. Date: Apr. 23, 2015

(54) TEMPERATURE SENSOR FOR RETAIL ENVIRONMENTS

(71) Applicants: T. Douglas Hoblit, Troy, OH (US); Richard C. Haber, Troy, OH (US)

(72) Inventors: T. Douglas Hoblit, Troy, OH (US); Richard C. Haber, Troy, OH (US)

(73) Assignee: Tagnetics, Inc., Troy, OH (US)

(21) Appl. No.: 14/520,835

(22) Filed: Oct. 22, 2014

Related U.S. Application Data
(63) Continuation-in-part of application No. 14/300,689, filed on Jun. 10, 2014.
Application No. 14/300,689 is a continuation-in-part of application No. 14/262,927, filed on Apr. 28, 2014.
Application No. 14/262,927 is a continuation-in-part of application No. 14/217,902, filed on Mar. 18, 2014.
(60) Provisional application No. 61/894,032, filed on Oct. 22, 2013.

(51) Int. Cl. G01K 1/02; G06K 7/14

(52) U.S. Cl. CPC G01K 1/028; G06K 7/14
USPC 374/141

(57) ABSTRACT

A system and method for monitoring temperatures in retail environment. The method includes associating temperature monitoring electronic shelf labels with a product and monitoring the temperature at the temperature monitoring electronic shelf label. When the monitored temperature is outside a predetermined range for the associated product, a warning is generated and transmitted to system users. Temperatures are also stored for each monitored product and zone for subsequent review. The temperature monitoring electronic shelf label comprises a temperature sensor integrated with an electronic shelf label, is mounted in a retail environment with temperature-sensitive products, and is connected to a low voltage power supply and communicates with an area controller.

### CROSS-REFERENCE TO RELATED APPLICATION

This application is a Continuation-in-Part of U.S. patent application Ser. No. 14/300,689 filed Jun. 10, 2014, which is a Continuation-in-Part of U.S. patent application Ser. No. 14/262,927 filed Apr. 28, 2014, which is a Continuation-in-Part of U.S. patent application Ser. No. 14/217,902 filed Mar. 18, 2014. This application claims priority to U.S. Provisional Patent Application Ser. No. 61/894,032 filed Oct. 22, 2013. The entirety of these applications are incorporated herein by reference.

### FIELD OF THE INVENTION

The present disclosure generally relates to temperature monitoring. More specifically, the present disclosure generally relates to a temperature sensor integrated with an electronic shelf label for use in retail environments.

### BACKGROUND

Many products sold to consumers today from retail stores are temperature-sensitive. Most commonly, these products must remain chilled while disposed on retail shelving and awaiting purchase or else risk spoilage. Examples include meat and seafood, frozen goods, and dairy to name but a few.

Spoilage of chilled products is a major concern for retailers because it presents a public health risk, causes an economic loss, and threatens to disrupt customer loyalty. For these reasons, retailers often collect temperature data from their chilled or refrigerated shelving units. This temperature data is generally collected manually by store employees who periodically check a thermometer or other temperature sensor in the chilled or refrigerated shelving units. In some cases, the manufacturer or installer of a retail refrigeration unit will include a temperature monitor as part of the unit's control system.

Temperature sensors available to retailers include simple thermometers, battery-powered sensors, and hard-wired sensors which use standard (120 V/60 Hz) power. Each of these sensors have drawbacks. Notably, the battery-powered sensors are problematic because of their limited battery lifespan, limited power output, and the high personnel and material costs to replace the batteries. The hard-wired sensors are expensive to install, may be subject to national and local electrical codes, and carry additional safety concerns such as the need to be encased in conduit.

Another concern in retail temperature monitoring is insufficient volume of data. For example, a chilled or refrigerated area of a retail store may have only a handful of temperature sensors. A long stretch of refrigerated shelving units or the entire meat and seafood display case may only have a single thermometer. In these circumstances, the data generated by the limited number of temperature sensors can be inadequate to prevent spoilage and ensure food safety; temperatures at one end of the display case could exceed product safety points while temperatures at the opposite end, which is monitored by a temperature sensor, remain adequate.

### SUMMARY OF THE DISCLOSURE

The present disclosure is directed to a temperature sensor which obviates many of the deficiencies cited above. The present disclosure is generally directed to a temperature sensor integrated with an electronic shelf label for use in retail environments. The temperature sensor and electronic shelf label are provided communications signals and low-voltage electrical power via inductive coupling. The present disclosure further provides a method of installing and operating the disclosed sensor, which comprises connecting a plurality of electronic shelf labels to an area controller, determining which of the plurality of electronic shelf labels will be used to monitor temperature, and assigning a temperature band or reporting interval to each electronic shelf label which will be used to monitor temperature.

In some embodiments of the present disclosure, a method of monitoring temperature in a retail environment is provided. The method includes associating products with temperature monitoring electronic shelf labels (ESL) which include at least an integrated temperature sensor, display, and microprocessor having a memory device. The association may be performed with a hand-held device which scans a label on the temperature monitoring electronic shelf label to obtain a unique ID of the temperature monitoring ESL and a universal product code of a product. The hand-held device may be in wireless communication with a tag area controller, to which the hand-held device transmits the unique IDs. The tag area controller stores the association of the product and the temperature monitoring ESL. The temperature monitoring ESL transmits a temperature measured by the temperature sensor to the tag area controller, which stores the temperature information. This information may be later reviewed by a user with a smart device, or on the area controller or a system controller operably connected to the area controller. The tag area controller further transmits display information to the temperature monitoring ESL indicating the price of a product, the sale price, and/or unit price. In some embodiments the method further provides for transmitting alarm notifications via email, text message, automated phone call, or computer notification if the temperature received at the tag area controller is outside a predetermined temperature range for the product. This may also include transmitting display information to the temperature monitoring ESL to display the alarm, the product temperature, or cause a light on the temperature monitoring ESL to illuminate.

In some embodiments of the present disclosure, a method of monitoring the temperature of distributed zones within a refrigerator case is provided. The method provides for associating more than one temperature monitoring ESL, distributed within the refrigerator case, with a product and a refrigerator zone. The association may use a hand-held controller to scan the label of the temperature monitoring ESL and universal product code of the product, and the association is stored. The temperature is monitored and stored for each refrigerator zone and its associated product. If the temperature for a refrigerator zone falls outside of a predetermined range for the product associated with the refrigerator zone, the an alarm notification is transmitted via email, text message, automated phone call, or computer notification indicating the alarming temperature, associated product, and refrigerator zone in which the alarm occurs. In some embodiments, the temperature monitoring electronic shelf label reports this alarm. In some embodiments the temperature monitoring ESL will display the product and refrigerator zone temperature, and, if required, an alarm and/or illuminate an indicator light.

In some embodiments of the present disclosure, a programmable temperature monitoring electronic shelf label network system is provided. The system provides at least one temperature monitoring ESL, comprising a temperature sensor, display, and microprocessor having a memory device, and a power distribution and communications subsystem for providing power and communications signals to the at least one temperature monitoring ESL. The subsystem may include a power supply, a distribution loop operatively connected to the temperature monitoring ESL, and a tag area controller operatively connected to the distribution loop and the power supply. The tag area controller is configured to associate each temperature monitoring ESL with a product, monitor a temperature signal received from each temperature monitoring ESL, and transmit display information to be displayed on the temperature monitoring ESL.

In some embodiments of the present disclosure, a temperature monitoring ESL is provided. The temperature monitoring ESL comprises a casing, a display, and information label, a microprocessor having a memory device, and a temperature sensor. The microprocessor is configured to receive a temperature signal from the temperature sensor, and to transmit this signal to a remote tag area controller. The microprocessor is further configured to receive display information comprising one of a price, sale price, or unit price of a product. The temperature monitoring ESL will display this information. In some embodiments the microprocessor is further configured to receive a predetermined temperature alarm set point, and to transmit and display an alarm if the measured temperature is outside of this set point. This display may include illuminating an indicator light on the temperature monitoring ESL.

### BRIEF DESCRIPTION OF THE DRAWINGS

The foregoing and other advantages of the present disclosure will become apparent upon reading the following detailed description and upon reference to the drawings.

FIG. 1 is a front profile view of a prior art electronic shelf label.

FIG. 2A is a front profile view of an electronic shelf labels in accordance with an embodiment of the present disclosure.

FIG. 2B is a front profile view of an electronic shelf labels in accordance with another embodiment of the present disclosure.

FIG. 2C is a front profile view of an electronic shelf labels in accordance with another embodiment of the present disclosure.

FIG. 2D is a front profile view of an electronic shelf labels in accordance with another embodiment of the present disclosure.

FIGS. 3A-C are simplified schematic diagrams of an electronic shelf label network in accordance with some embodiments.

FIG. 4 is a simplified block diagram of the elements of an electronic shelf label in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

The present disclosure is generally intended to be used in conjunction with a low-voltage, inductively-coupled system such as that disclosed in U.S. Pat. Nos. 5,537,126; 5,736,967; 6,089,453; 6,249,263; 6,271,807; and 6,844,821, which are herein incorporated in their entirety. However, the present disclosure may be used with additional systems and devices which employ inductive coupling to provide power and/or communication or control signals.

Although many examples an illustrative embodiments of this disclosure involve retail products that must be cold stored, the disclosure may also be directed at retail products that must be provided to a customer hot, such as heated foods. Various features of the present disclosure would thus be adjusted to the specific concerns of heated food. For example, the high temperature warning disclosed below for chilled foods would become a low temperature warning for heated foods. In both instances, the warning is set to notify retail store employees or system users of an undesired temperature condition.

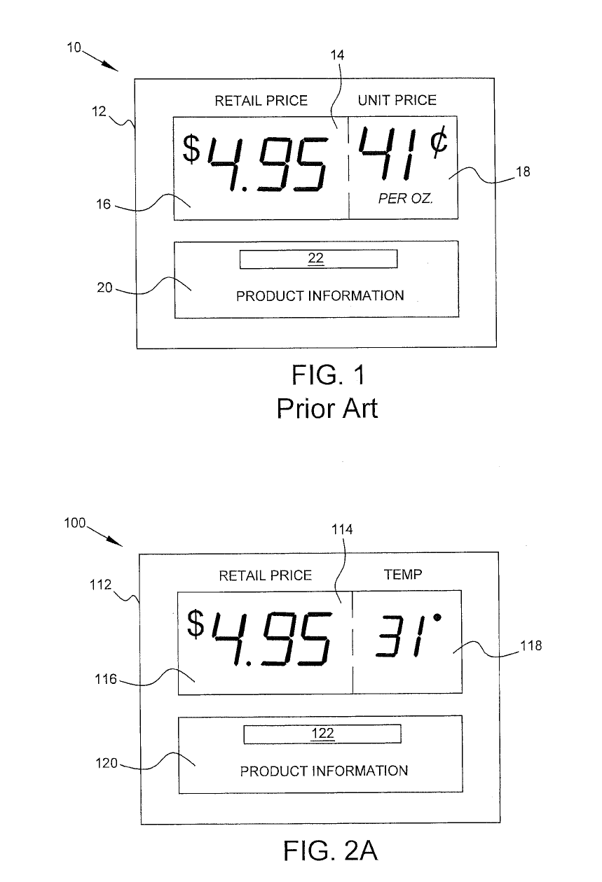

FIG. 1 is a typical prior art shelf label. ESLs 10 are used in the place of traditional price labels on retail shelves to enable retailers to update their price tags electronically. A typical ESL 10, as illustrated in FIG. 1 comprises various electronic elements disposed within a casing 12. A display 14 is disposed on the front face of the ESL 10. In FIG. 1, display 14 is divided into a primary display area 16 and secondary display area 18. In the illustrated embodiment, primary display area 16 is used to display the retail price of a retail item, while secondary display area 18 is used to display the unit price. The front face of an ESL 10 also typically includes a product information label 20 which may include a bar code 22.

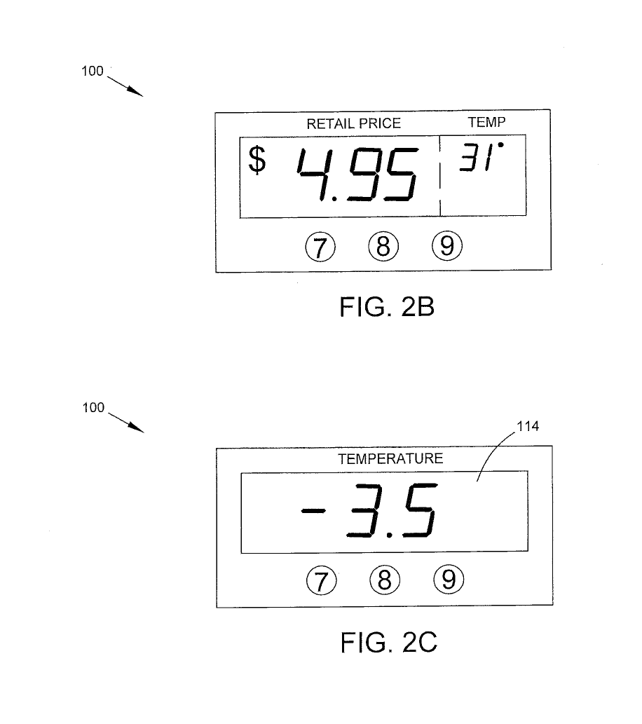

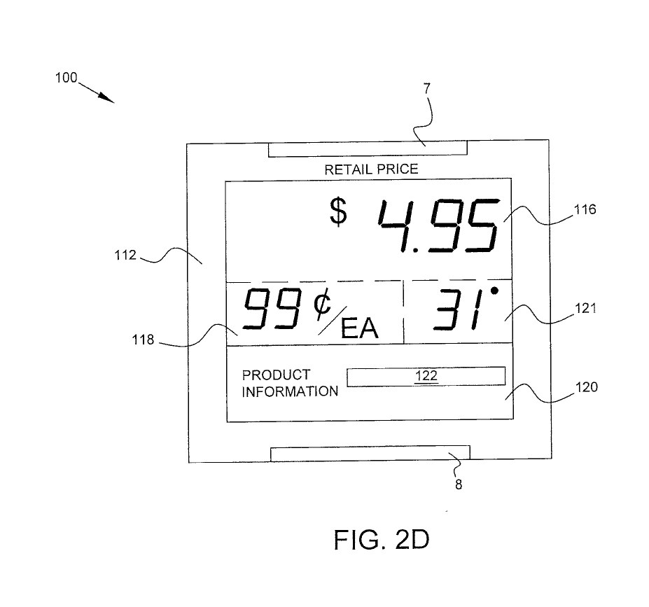

In one embodiment of the present disclosure, ESL 100, shown in FIG. 2A, a secondary display area 118 is used to display a temperature. The ESL 100 comprises various electronic elements disposed within a casing 112. The front face of this casing 112 is shown. A display 114 is disposed within the front face of the ESL 100. In FIG. 2A, display 114 is divided into a primary display area 116 and secondary display area 118. In the illustrated embodiment, primary display area 116 is used to display the retail price of a retail item, while secondary display area 118 is used to display the measured product temperature. The front face of an ESL 100 also typically includes a product information label 120 which may include a bar code 122, QR code, or other code which can be scanned.

In a second illustrated embodiment of an ESL 100, shown in FIG. 2B, product information label 120 is replaced with a first indicator light 7, second indicator light 8, and third indicator light 9. In some embodiments, the indicator lights 7, 8, and 9 comprise LEDs. In some embodiments, the indicator lights 7, 8, and 9 are green, amber, and red, respectively, to indicate the temperature condition of the ESL 100 as will be discussed in more detail below.

In a third embodiment of an ESL 100, shown in FIG. 2C, display 114 displays a temperature. This illustrated embodiment also includes a first indicator light 7, second indicator light 8, and third indicator light 9.

In a fourth embodiment of an ESL 100, shown in FIG. 2D, display 114 comprises primary display area 116, secondary display area 118, and tertiary display area 121. In some embodiments, primary display area 116 is disposed above secondary display area 118 and tertiary display area 121. The three display areas of display 114 are capable of numerous configurations to display various parameters, as detailed in Table 1 below. In some embodiments, ESL 100 further comprises first indicator light 7, second indicator light 8, and third indicator light 9.

TABLE 1
Display Configurations

| Primary Display Area | Secondary Display Area | Tertiary Display Area |
|---|---|---|
| Retail Price | Unit Price | Blank |
| Sale Price | Unit Price | Regular Price |
| Sale Price | Unit Price | Savings |
| Temperature | Blank | Blank |
| Retail Price | Unit Price | Temperature |
| Sale Price | Unit Price | Temperature |
| Retail Price | Set Temperature | Actual Temperature |
| Actual Temperature | Low Range set point | High Range set point |

In still further embodiments, an ESL 100 is programmed to display retail price and temperature on the same display 114 at alternating intervals (e.g. —display retail price for 10 seconds, then display temperature for 5 seconds, then display retail price again for 10 seconds). In another embodiment, a scroll button (not shown) on the ESL 100 allows a user to scroll through the various displays. This may include switching between a product price display and the product temperature on-demand.

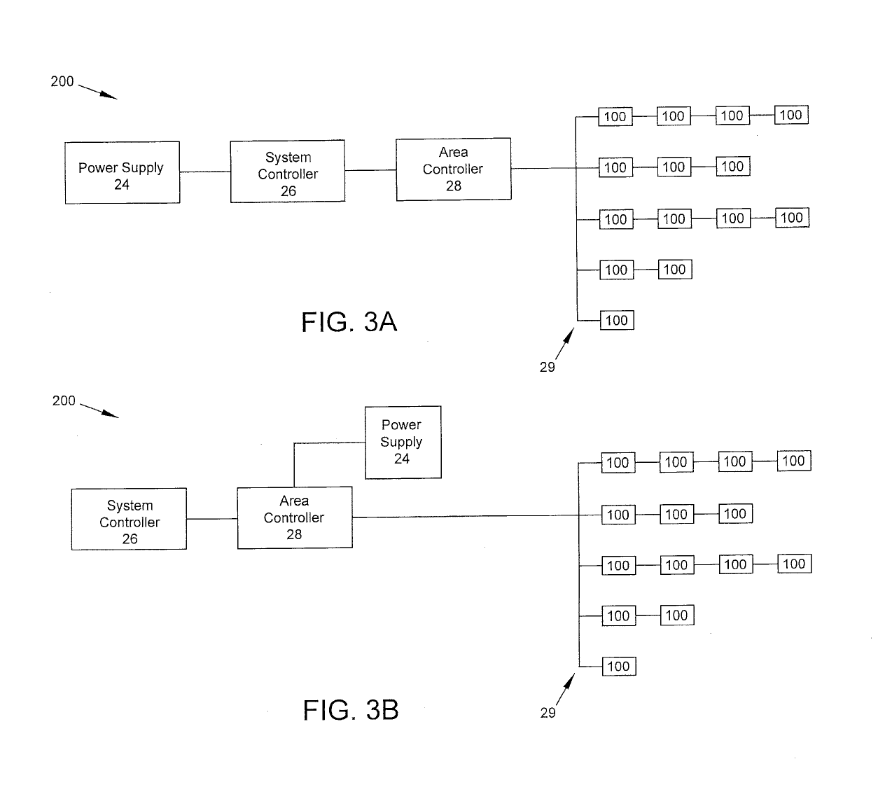

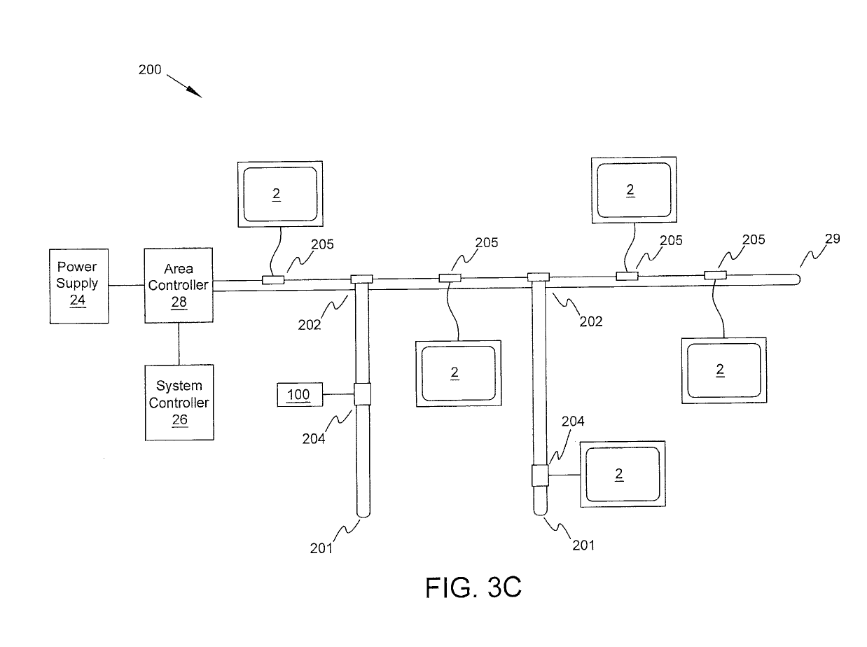

FIGS. 3A-C are schematic diagrams of an ESL network 200 in accordance with some embodiments. ESLs 100 are disposed on retail shelves throughout a retail store and connected in a network 200. In some embodiments, the network 200 comprises a plurality of ESLs 100, at least one area controller 28, a system controller 26, a power supply 24, and a distribution loop 29. In some embodiments, the system controller 26 controls a plurality of area controllers 28, with each area controller 28 responsible for controlling a plurality of ESLs 100 in a specific area of a retail store. For example, in some embodiments a retail store is assigned a single system controller 26 while a separate area controller 28 is assigned for each aisle of the retail store. In some embodiments, the power supply 24, area controller 28, system controller 26, and distribution loop 29 are referred to as a power distribution and communications system or subsystem.

In some embodiments, as illustrated in FIG. 3A, power supply 24 is operatively connected to system controller 26, which is operatively connected to area controller 28. Area controller is further operatively connected to a plurality of ESLs 100 via a distribution loop 29.

In some embodiments, as illustrated in FIG. 3B, power supply 24 is operatively connected to area controller 28, which is operatively connected to a plurality of ESLs 100 via distribution loop 29. Area controller 28 is further operatively connected to system controller 26. In some embodiments, system controller 26 is wirelessly connected to area controller 28.

FIG. 3C is a schematic diagram of an ESL network 200 for at least one ESL 100 in accordance with some embodiments. In some embodiments, ESL network 200 distributes power and communication signals to a ESLs 100. In some embodiments, ESL network 200 additionally distributes power to a plurality of video monitors 2, or other components such as promotion displays and inventory sensors.

In some embodiments power supply 24 is a standard wall outlet well known in the art. Electrical power flows through an area controller 28 to a power stringer 29. In some embodiments the area controller 28 is a power tag area Controller. In some embodiments the power stringer 29 is called the primary distribution loop. In some embodiments power stringer 29 distributes power at between 45 and 50 VAC, 50 KHz, and 1 ampere. A frequency of 50 KHz was selected in part to comply with applicable regulatory requirements.

Power stringer 29 conveys power from the area controller 28 to at least one ESL 100. In some embodiments, power stringer 29 additionally conveys power to at least one secondary distribution loop 201. A secondary distribution loop 201 may also be referred to as a riser. Each ESL 100 is connected to the power stringer 29 or a secondary distribution loop 201 via a power coupler 204. Each video monitor 2 is connected to the power stringer 29 via a power converter 205. Each secondary distribution loop 201 is connected to power stringer 29 via a primary-secondary connection 202. In some embodiments, the primary-secondary connection 202 is a step-down transformer which maintains the secondary distribution loop 201 at a lower voltage, frequency, and/or amperage than the power stringer 29. In other embodiments, the primary-secondary connection 202 maintains the secondary distribution loop 201 at the same voltage, frequency, and amperage as power stringer 29.

In the embodiments, such as that pictured in FIG. 3C, a plurality of video monitors 2 are connected to a single power supply 24 using a single power stringer 29 and a plurality of power converters 205. In some embodiments, a plurality of video monitors 2 may receive electrical power by a plurality of power supplies 24 or a plurality of power stringers 29. In some embodiments, the power supply 24 is connected to a power stinger 29 via inductive coupling. In some embodiments, at least one video monitor 2 is powered via the secondary distribution loop using a power coupler 204.

In some non-limiting embodiments, power converter 205 and power coupler 204 are those described in U.S. patent application Ser. No. 14/217,902.

In some embodiments, area controller 28 is a tag area controller as used in a system of electronic shelf labels such as that disclosed in U.S. Pat. Nos. 5,537,126; 5,736,967; 6,249,263; 6,271,807; and 6,844,821. In other embodiments, area controller 28 may be removed from ESL network 200 allowing each power converter 205 and power coupler 204 to connect to the power supply 24. In some embodiments, the area controller 28 is an electrical power strip. In some embodiments, the control for an area controller 28 is provided by a system controller 26.

In some embodiments, a plurality of ESLs 100 receive electrical power from a plurality of power supplies 24 or a plurality of low voltage power stringers 29.

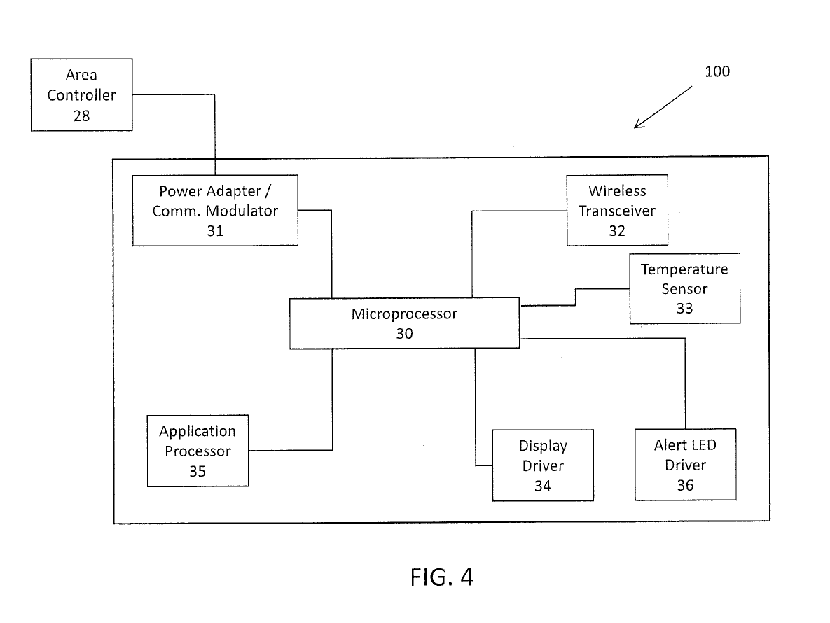

FIG. 4 is a block diagram of the elements of an ESL 100 in accordance with some embodiments. The electronic elements of an ESL 100 include, but are not limited to, a microprocessor 30 having a memory device, power adapter and communications modulator 31, wireless transceiver 32, temperature sensor 33, display driver 34, application processor 35, and alert LED driver 36 (also known as an indicator light driver). In some embodiments these elements are housed within the casing 112 with the display 114 and product information 120 housed on the front of the casing. In some embodiments, the ESL 100 may include a separate communications module for communicating with the area controller 28 and system controller 26 via the distribution loop or wirelessly. The microprocessor performs all command and control functions of the ESL 100 and is connected to the area controller 28 through power adapter and communications modulator 31, which adjusts electrical power to a voltage, amperage, and frequency suitable to the microprocessor 30 and additional elements. The area controller 28 supplies electrical power and command and communications signals to each of a plurality of ESLs 100. In some embodiments, the ESL 100 is connected to the area controller 28 via inductive coupling. In some embodiments, the microprocessor is a MSP430 Ultra-Low-Power Microcontroller by Texas Instruments.

Providing a temperature sensor 33 disposed within an ESL 100 enables a retailer to continuously monitor temperature at a plurality of locations throughout a retail store. Further, the disclosed configuration enables a retailer to collect data from each of the plurality of temperature sensors 33 disposed throughout the retail environment.

In some embodiments, the system controller 26 is a personal computer. In other embodiments, the system controller 26 is connected to or in communication with a personal computer. In some embodiments, the system controller 26 and/or attached personal computer is used to establish temperature setpoints for the plurality of ESLs 100, either collectively or individually. Warnings are issued via notifications when a temperature reaches a first setpoint (also known as a predetermined temperature warning set point), and alarm is activated when a temperature reaches or meets a second setpoint (also known as a predetermined temperature alarm set point). For example, certain ice cream products are recommended to be stored below 0° F. and begin to degrade at temperatures above 10° F. For an ESL 100 assigned to these products, a warning could be set to activate at −5° F. and an alarm could be set to activate at 5° F. This would warn retail employees when the temperature was in danger of exceeding the recommended storage temperature and would provide an alarm when the temperature was in danger of exceeding a degradation temperature for that product. Since each ESL 100 can be programmed with different setpoints, each product's specific temperature needs can be accounted for.

In some embodiments, a warning is provided on the ESL 100 itself, such as in the form of a yellow or amber warning light or by having the display 114 of the ESL 100 flash on and off. In some embodiments, the flashing display 114 further includes text displayed on the display 114 such as “HIGH” or “HIGH TEMP”. In some embodiments, the warning light is one of first indicator light 7, second indicator light 8, or third indicator light 9. In some embodiments, a warning is reported by the ESL 100 to the system controller 26 and/or the attached personal computer. In some embodiments, a warning is further reported by transmitting to retail store employees via email, text messages, phone calls, and computer notifications.

In some embodiments, an alarm is provided on the ESL 100 itself, such as in the form of a red warning light or by having the display 114 of the ESL 100 flash on and off. In some embodiments, the flashing display 114 further includes text displayed on the display 14 such as “HIGH” or “HIGH TEMP”. In some embodiments, the alarm light is one of first indicator light 7, second indicator light 8, or third indicator light 9. In some embodiments, an alarm is reported by the ESL 100 to the system controller 26 and/or the attached personal computer. In some embodiments, an alarm is further transmitted to retail store employees via email, text messages, phone calls, and computer notifications. In some embodiments the warnings and alarms are provided by the ESL 100. In some embodiments, the warnings and alarms are provided by the system controller 26.

In some embodiments, additional warnings or alarms are provided for violations of food safety guidelines based on temperature and timing. For example, where a refrigeration unit has a high temperature alarm that is not cleared for a predetermined number of hours, the food products in that unit may become compromised and an additional food safety alarm may be provided to retailers to inform them that the food products therein are no longer safe for sale and must be discarded. In some embodiments, such warnings and alarms are provided via system controller 26.

In some embodiments, the ESL 100 is additionally capable, via wireless transceiver 32, of wireless communication with various handheld smart devices which a retail store employee or customer may wish to use. For example, an ESL 100 communicates with a smartphone to provide a customer information regarding (1) the temperature measured by the ESL 100 and (2) the safety requirements of the retail product associated with that ESL 100. The wireless communications may occur via WiFi, Bluetooth, infrared beam, RFID, or other NFC (Near Field Communication) technology. As another example, an ESL 100 communicates with a retail store employee's handheld device to provide (1) the temperature measured by the ESL 100, (2) the safety requirements of the retail product associated with that ESL 100, and (3) the duration of time which the ESL 100 has been in an alarming or warning condition. Additionally, this information may be provided to customers or employees in comprehensive history of the product temperature. In some embodiments the system controller 26 and/or area controller 28 can perform these communications with the smart devices instead or in addition to the ESL 100.

In some embodiments, the system controller 26 and/or attached personal computer store temperature data for a predetermined period of time, allowing a user to view historical temperature trends. This data may be transmitted to a smart device such as a phone or tablet for review by a user, and may also be viewed directly on the tag area controller 28 or system controller 26. For example, historical trends may be used to identify refrigeration units that are not working properly. Where a refrigeration unit operates under generally steady load conditions (i.e., steady volume of contents, steady customer use, steady ambient temperature), rising temperatures in the refrigeration unit may indicate maintenance is required such as re-charging the refrigerant, changing an air filter, etc. As another example, monitoring trends can show when a freezer has been overloaded during re-stocking by monitoring trends in the time it takes to reach desired temperature after re-stock.

The present disclosure further provides a method for installing the disclosed ESL 100 with temperature sensor 33. An ESL 100 with integrated temperature sensor 33 is connected via inductive coupling to an area controller 28 which is connected or in communication with a system controller 26. Upon initial installation, the temperature sensing function of the ESL 100 may be disabled or inactive. The ESL 100 is assigned an address. A user links the ESL 100 with a specific retail product by scanning the ESL's information label (barcode, QR code, or equivalent) and the product's UPC. The information scanned by the user is transmitted to the system controller 26, wherein the system controller will associate the ESL 100 with the scanned product's UPC and store this association in memory. A user may also associate the ESL 100 with a refrigerator zone within a refrigerator case in a similar manner. Here, the ESL 100 may be associated with only with a product, a refrigerator zone, or with both a product and a refrigerator zone. In some embodiments, the user may manually select or enter a product's UPC code to be associated with a specific ESL using the system controller 26. While the system controller 26 is described here as receiving and associating ESL and product UPC data, it is understood that the area controller 28 may also perform these functions. For the purposes of communications with the ESL 100, the terms system controller 26 and area controller 28 may be used interchangeably.

The area controller 28 assigns at least one ESL 100 to monitor temperature. The area controller may select which ESLs 100 will monitor temperature automatically or through user input. The ESL may also show the measured temperature on its display. The area controller 28 then assigns to each ESL 100 which will monitor temperature a set of predetermined conditions. For example, in some embodiments an ESL 100 is assigned a predetermined temperature band or range, e.g. −10° F. to 30° F., and the ESL 100 will report an alarm to the area controller 28 only if measured temperature leaves the assigned band. As another example, an ESL 100 is ordered to report temperature to the area controller 28 at a predetermined reporting interval which may or may not be a set or fixed interval, and may be only when an alarming or warning condition occurs. In some embodiments, the area controller 28, system controller 26, or attached personal computer receives the temperature data from the ESL 100 and determines whether a warning or alarming condition exist. In this embodiment, the system controller 26 may be configured to direct one or more indicating lights on the ESL 100 to illuminate, or cause a high temperature warning to show on the ESL 100 display.

In some embodiments, ESL 100 is configured to wirelessly communicate with hand-held controllers allowing retailers to individually adjust ESL settings at the shelf. The hand-held controller may be operably connected, via wireless or other means, to the ESL 100, system controller 26 and/or area controller 28. While it may be described that the ESL 100 is in wireless communication with the hand-held controller, it will should be understood that this may be an indirect communication through other components in the network system, such as the system controller 26 and/or area controller 28. Further, in some embodiments, ESL setpoints (i.e., unit price, temperature warning, temperature alarm, etc.) are predetermined and stored in a database operatively connected to system controller 26. In some embodiments, setpoint information is stored in the database associated with a product UPC. When a retailer uses a hand-held controller to set an ESL at the shelf as associated with a certain product, the retailer need only scan a UPC and ESL information label to obtain the unique ID of the product and ESL. The hand-held controller transmits the unique ID of the product and ESL to the system controller 26 and/or area controller 28. The ESL setpoints and display information will automatically be identified and uploaded from the system controller 26 to the ESL 100 and displayed and monitored by the ESL 100 as necessary. For example, if a retailer is switching the position of a first product and second product at the shelf, a first ESL can be switched from the first product to second product simply by scanning the second product UPC with the hand-held controller after scanning the ESL information label. Associated UPC information (display configuration, the predetermined temperature range, predetermined reporting interval, etc.) is then communicated to the ESL through the area controller 28 and/or system controller 26, which is updated based on the stored, predetermined setpoints associated with second product. The updated ESL is now displaying the price associated with second product and monitoring for high temperature conditions and food safety violations based on the specific, predetermined temperature needs of the second product.

In some embodiments, the area controller 28 further designates which ESLs 100 will display temperature on their displays 114.

In some embodiments, the area controller 28 designates an ESL 100 as a stand-alone temperature monitor. In this embodiment, the ESL 100 need not be linked with a specific retail product. In this embodiment, the ESL 100 need not display a retail price. In this embodiment, the ESL 100 is assigned a temperature band or reports temperatures at predetermined intervals, as discussed above.

In some embodiments, a temperature calibration is performed on the ESL 100 once it is connected to the area controller 28.

Using the method of installation and activation disclosed above, a network of temperature sensors is able to be deployed throughout a retail environment to monitor the environment for acceptable temperatures. This network is advantageous because it provides many more data points than existing stand-alone temperature monitor systems.

In some embodiments, the system controller 26 and/or attached personal computer are connected to a network, such as the Internet, which allows for remote monitoring of temperature sensors. For example, a retailer may connect his temperature monitoring network to a larger corporate network, which allows corporate employees in remote locations to monitor temperatures inside the retail environment. In some embodiments, a retail store employee is able to check the status of the temperature monitoring network remotely during off hours while the retail store is closed. The ability to remotely transmit distributed temperatures throughout a refrigerator case and the retail store advantageously lowers costs. For example, maintenance personnel can receive more information regarding refrigerator temperatures, and potentially system health status, without the need to travel to each store.

In some embodiments, the system controller 26 and/or attached personal computer are configured to send status reports to a predetermined set of system users or retail store employees at a predetermined interval which may or may not be a set or fixed interval. Status reports are implemented as e-mails, text messages, FTP files, or computer notifications. Status reports may include alarming or warning conditions.

The present disclosure includes many advantages over the existing art. Most notably, the low voltage power supply is less expensive to install than a standard 120V electrical system. Due to its low voltage, power supply also has significantly fewer safety concerns and code requirements. The present disclosure also eliminates the need to change batteries—a time- and labor-intensive process that adds to a retailer's expense of maintaining a promotional system. Further, by integrating the temperature sensor with the electronic shelf label, a retailer is able to produce a sufficient volume of temperature data to effectively monitor trends, set and evaluate alarm setpoints, and ensure adequate temperatures are maintained. Finally, the disclosed system is more reliable than a battery-powered system because it does not require frequent replacement of the power source and provides hard-wired communications between ESL and the area and system controllers.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this.

While this specification contains many specifics, these should not be construed as limitations on the scope of any disclosures, but rather as descriptions of features that may be specific to particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

What we claim is:

1. A method of temperature monitoring of distributed refrigerator zones temperatures within a refrigerator case, comprising:
distributing more than one temperature monitoring electronic shelf label within a refrigerator case, wherein the temperature monitoring electronic shelf labels comprise a temperature sensor, a display, an information label, and a microprocessor having a memory device each housed within a casing, wherein the temperature monitoring electronic shelf label is operatively connected to a tag area controller which is remote from the temperature monitoring electronic shelf label;
associating each temperature monitoring electronic shelf label with a product and refrigerator zone in which the product will be placed, wherein the associating comprises:
scanning the information label to obtain a unique ID of the temperature monitoring electronic shelf label;
scanning a universal product code to obtain a unique ID of the product;
associating the unique ID of the temperature monitoring electronic shelf label and the unique ID of the product; and
storing the association;
monitoring a temperature at each temperature monitoring electronic shelf label, wherein monitoring comprises:
measuring, by the temperature sensor, the temperature of the refrigerator zone monitored by the temperature monitoring electronic shelf label; and
storing the temperature; and
displaying, by the temperature monitoring electronic shelf label, display information comprising one of a product price, sale price, or unit price, received by the temperature monitoring electronic shelf label.

2. The method of claim 1, further comprising:
transferring the temperature of each refrigerator zone as measured by each temperature sensor to a smart device for display;
comparing the measured temperature of each refrigerator zone to a predetermined temperature range for the product associated with the refrigerator zone;
reporting, by the tag area controller, an alarm if the measured temperature is outside of the predetermined temperature range, wherein reporting the alarm comprises transmitting an alarm notification indicating the alarm temperature, refrigerator zone, and associated product via email, text message, automated phone call, or computer notification.

3. The method of claim 2, wherein each temperature monitoring electronic shelf label further comprises a first indicator light and an indicator light driver, each housed within the casing, and wherein the display information causes the first indicator light to illuminate if the temperature as measured by the temperature sensor is outside of the predetermined temperature range for the product associated with the refrigerator zone.

4. The method of claim 1, wherein each temperature monitoring electronic shelf label further comprises a first indicator light and an indicator light driver, each housed within the casing, further comprising:
displaying the temperature of each refrigerator zone as measured by each temperature sensor on the temperature monitoring electronic shelf label for that refrigerator zone;
comparing the measured temperature of each refrigerator zone to a predetermined temperature range for the product associated with the refrigerator zone; and
reporting, by the temperature monitoring electronic shelf label, an alarm if the measured temperature is outside of the predetermined temperature range, wherein reporting the alarm comprises transmitting an alarm notification indicating the alarm temperature, refrigerator zone, and associated product and illuminating the first indicator light.

5. A method of monitoring temperature in a retail environment, comprising:
associating a product with a temperature monitoring electronic shelf label, the temperature monitoring electronic shelf label comprising a temperature sensor, a display, and a microprocessor having a memory device each housed within a casing;
storing the association;
monitoring a temperature at the temperature monitoring electronic shelf label, wherein monitoring comprises:
measuring, by the temperature sensor, the temperature at a retail shelf; and
storing the temperature; and
displaying, by the temperature monitoring electronic shelf label, display information comprising one of a product price, sale price, or unit price, received by the temperature monitoring electronic shelf label from the tag area controller.

6. The method of claim 5, wherein the temperature monitoring electronic shelf label further comprises an information label, and associating the product with the temperature monitoring electronic shelf label comprises:
scanning the information label to obtain a unique ID of the temperature monitoring electronic shelf label;
scanning a universal product code to obtain a unique ID of the product; and
associating the unique ID of the temperature monitoring electronic shelf label and the unique ID of the product.

7. The method of claim 6, further comprising:
transferring the temperature as measured by the temperature sensor to a smart device for display.

8. The method of claim 7, where monitoring the temperature further comprises:
comparing the temperature to a predetermined temperature range; and
reporting, by the tag area controller, an alarm if the temperature is outside of the predetermined temperature range.

9. The method of claim 8, wherein reporting the alarm comprises transmitting, by the tag area controller, an alarm notification via email, text message, automated phone call, or computer notification.

10. The method of claim 8, wherein the temperature monitoring electronic shelf label further comprises a first indicator light and an indicator light driver, each housed within the casing, and wherein the display information from the tag area controller further comprises the alarm notification and causes the first indicator light illuminate if the temperature is outside of the predetermined temperature range.

11. The method of claim 10, further comprising displaying, by the temperature monitoring electronic shelf label, a product temperature or an alarm, wherein the display information received from the tag area controller further comprises one of the product temperature or the alarm.

12. The method of claim 6, further comprising:
assigning set points to the temperature monitoring electronic shelf label, wherein assigning set points comprises:
identifying a predetermined temperature range of the product;
transmitting the predetermined temperature range to the temperature monitoring electronic shelf label; and
storing the predetermined temperature range in the memory device of the temperature monitoring electronic shelf label; and
wherein monitoring the temperature further comprises comparing the temperature as measured by the temperature sensor to the predetermined temperature range; and
wherein transmitting the temperature further comprises transmitting, by the temperature monitoring electronic shelf label, an alarm to the tag area controller if the temperature is outside of the predetermined temperature range.

13. The method of claim 12, further comprises transmitting an alarm notification via email, text message, automated phone call, or computer notification.

14. The method of claim 13, wherein the temperature monitoring electronic shelf label further comprises a first indicator light and an indicator light driver, each housed within the casing, and wherein the temperature monitoring electronic shelf label illuminates the first indicator light if the temperature is outside of the predetermined temperature range.

15. The method of claim 12, wherein displaying further comprises displaying, by the temperature monitoring electronic shelf label, the temperature as measured by the temperature sensor.

16. A programmable temperature monitoring electronic shelf label network system, comprising:
at least one temperature monitoring electronic shelf label comprising a temperature sensor, a display, and a microprocessor having a memory device each housed within a casing of the temperature monitoring electronic shelf label wherein the microprocessor is operably connected to the temperature sensor, and display; and
a power distribution and communications subsystem for providing power and communications signals to the at least one temperature monitoring electronic shelf label, comprising:
a power supply;
a distribution loop operatively connected to the at least one temperature monitoring electronic shelf label; and
a tag area controller operatively connected to the power supply and distribution loop wherein the tag area controller is configured to:
associate the at least one temperature monitoring electronic shelf label with a product to be monitored monitor;
monitor a temperature of the product by receiving a temperature signal transmitted from the microprocessor; and
transmit display information to the temperature monitoring electronic shelf label.

17. The system of claim 16, further comprising:
a hand-held controller operatively connected to the tag area controller, wherein the at least one temperature monitoring electronic shelf label further comprises an information label, and the hand-held controller is configured to:
scan the information label and transmit a unique ID of the at least one temperature monitoring electronic shelf label to the tag area controller; and
scan a universal product code of the product and transmit a unique ID of the product to the tag area controller, wherein the tag area controller associates the at least one temperature monitoring electronic shelf label and product by receiving the unique ID of the at least one temperature monitoring electronic shelf label and the product.

18. A temperature monitoring electronic shelf label, comprising:
a casing having a front face and a rear face;
a display, disposed within the front face of the casing,
an information label disposed on the front face of the casing, wherein the information label comprises one of a barcode or a QR code;
a microprocessor disposed within the casing having a memory device, a display driver, and a communications module; and
a temperature sensor disposed within the casing and operably connected to the microprocessor, wherein the microprocessor is configured to:
receive a measured temperature signal from the temperature sensor, and transmit the measured temperature to a tag area controller;
receive display information from the tag area controller comprising one of a price, sale price, or unit price for a product; and
display the display information.

19. The temperature monitoring electronic shelf label of claim 18, further comprising:
a first indicator light disposed within the front face of the casing;
wherein the display comprises a primary display area and a secondary display area, and the primary display area is configured to display a product price and the secondary display area is configured to display a measured temperature;
wherein the a microprocessor further comprises an indicator light driver, and the microprocessor is operably connected to the first indicator light and is configured to:
receive a predetermined temperature alarm set point for the product from the tag area controller;
store the predetermined temperature alarm set point;
display the measured temperature on the display;
illuminate the first indicator light and transmit an alarm notification to a tag area controller when the measured temperature signal meets the predetermined temperature alarm set point.

20. The temperature monitoring electronic shelf label of claim 19, further comprising:
a second indicator light disposed within the front face of the casing, wherein the microprocessor is further configured to receive a predetermined temperature warning set point, and to cause the second indicator light to illuminate and transmit a warning notification to the tag area controller when the measured temperature signal meets the predetermined temperature warning set point.

21. The temperature monitoring electronic shelf label of claim 20, wherein the display further comprises a tertiary display area configured to display one of a retail price, a sale price, a unit price, a regular price, a savings, a temperature as measured by the temperature sensor, a set temperature, a low range set point, or a high range set point.

22. The temperature monitoring electronic shelf label of claim 18, further comprising a first indicator light disposed within the front face of the casing, wherein the display information further comprises an alarm and the microprocessor further comprises an indicator light driver, wherein the microprocessor is operably connected to the first indicator light and is configured to illuminate the first indicator light when in receipt of an alarm.
